(19) United States
(12) Patent Application Publication
(10) Pub. No.: US 2010/0315413 A1
(43) Pub. Date: Dec. 16, 2010

(54) Surface Computer User Interaction

(75) Inventors: Shahram Izadi, Cambridge (GB); Nicolas Villar, Cambridge (GB); Otmar Hilliges, Munich (DE); Stephen E. Hodges, Cambridge (GB); Armando Garcia-Mendoza, Barcelona (ES); Andrew David Wilson, Seattle, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/485,499

(22) Filed: Jun. 16, 2009

(51) Int. Cl. G09G 5/00; G06T 15/20

(52) U.S. Cl. 345/419; 345/156

(57) ABSTRACT

Surface computer user interaction is described. In an embodiment, an image of a user's hand interacting with a user interface displayed on a surface layer of a surface computing device is captured. The image is used to render a corresponding representation of the hand. The representation is displayed in the user interface such that the representation is geometrically aligned with the user's hand. In embodiments, the representation is a representation of a shadow or a reflection. The process is performed in real-time, such that movement of the hand causes the representation to correspondingly move. In some embodiments, a separation distance between the hand and the surface is determined and used to control the display of an object rendered in a 3D environment on the surface layer. In some embodiments, at least one parameter relating to the appearance of the object is modified in dependence on the separation distance.

### BACKGROUND

Traditionally, user interaction with a computer has been by way of a keyboard and mouse. Tablet PCs have been developed which enable user input using a stylus, and touch sensitive screens have also been produced to enable a user to interact more directly by touching the screen (e.g. to press a soft button). However, the use of a stylus or touch screen has generally been limited to detection of a single touch point at any one time.

Recently, surface computers have been developed which enable a user to interact directly with digital content displayed on the computer using multiple fingers. Such a multi-touch input on the display of a computer provides a user with an intuitive user interface. An approach to multi-touch detection is to use a camera either above or below the display surface and to use computer vision algorithms to process the captured images.

Multi-touch capable interactive surfaces are a prospective platform for direct manipulation of 3D virtual worlds. The ability to sense multiple fingertips at once enables an extension of the degrees-of-freedom available for object manipulation. For example, while a single finger could be used to directly control the 2D position of an object, the position and relative motion of two or more fingers can be heuristically interpreted in order to determine the height (or other properties) of the object in relation to a virtual floor. However, techniques such as this can be cumbersome and complicated for the user to learn and perform accurately, as the mapping between finger movement and the object is an indirect one.

The embodiments described below are not limited to implementations which solve any or all of the disadvantages of known surface computing devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Surface computer user interaction is described. In an embodiment, an image of a user's hand interacting with a user interface displayed on a surface layer of a surface computing device is captured. The image is used to render a corresponding representation of the hand. The representation is displayed in the user interface such that the representation is geometrically aligned with the user's hand. In embodiments, the representation is a representation of a shadow or a reflection. The process is performed in real-time, such that movement of the hand causes the representation to correspondingly move. In some embodiments, a separation distance between the hand and the surface is determined and used to control the display of an object rendered in a 3D environment on the surface layer. In some embodiments, at least one parameter relating to the appearance of the object is modified in dependence on the separation distance.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a schematic diagram of a surface computing device;

FIG. 2 shows a process for enabling a user to interact with a 3D virtual environment on a surface computing device;

FIG. 3 shows hand shadows rendered on a surface computing device;

FIG. 4 shows hand shadows rendered on a surface computing device for hands of differing heights;

FIG. 5 shows object shadows rendered on a surface computing device;

FIG. 6 shows a fade-to-black object rendering;

FIG. 7 shows a fade-to-transparent object rendering;

FIG. 8 shows a dissolve object rendering;

FIG. 9 shows a wireframe object rendering;

FIG. 10 shows a schematic diagram of an alternative surface computing device using a transparent rear projection screen;

FIG. 11 shows a schematic diagram of an alternative surface computing device using illumination above the surface computing device;

FIG. 12 shows a schematic diagram of an alternative surface computing device using a direct input display; and

FIG. 13 illustrates an exemplary computing-based device in which embodiments of surface computer user interaction can be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a surface computing system, the system described is provided as an example and not a limitation. As those skilled in the art will appreciate, the present examples are suitable for application in a variety of different types of touch-based computing systems.

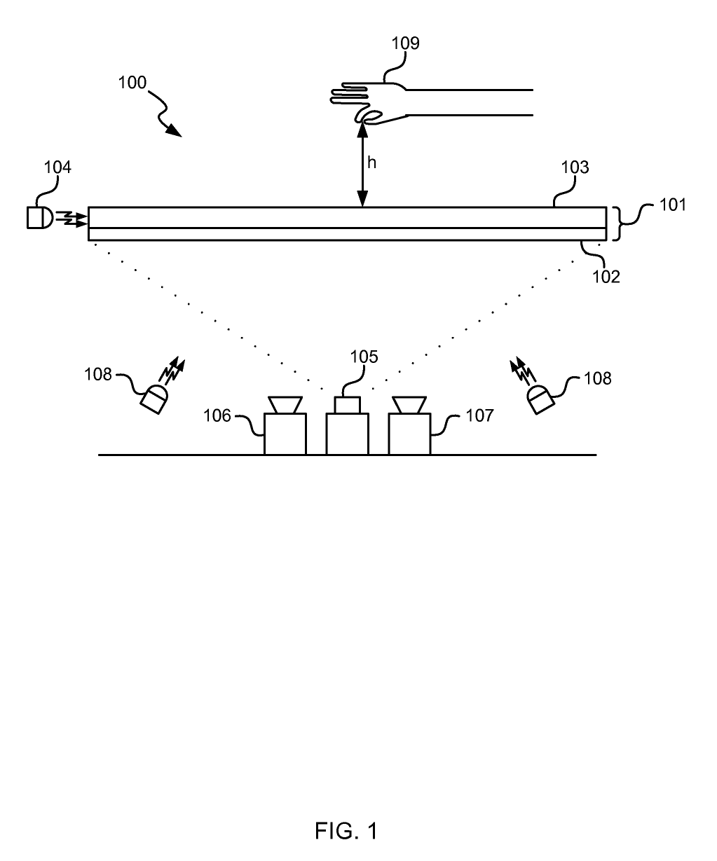

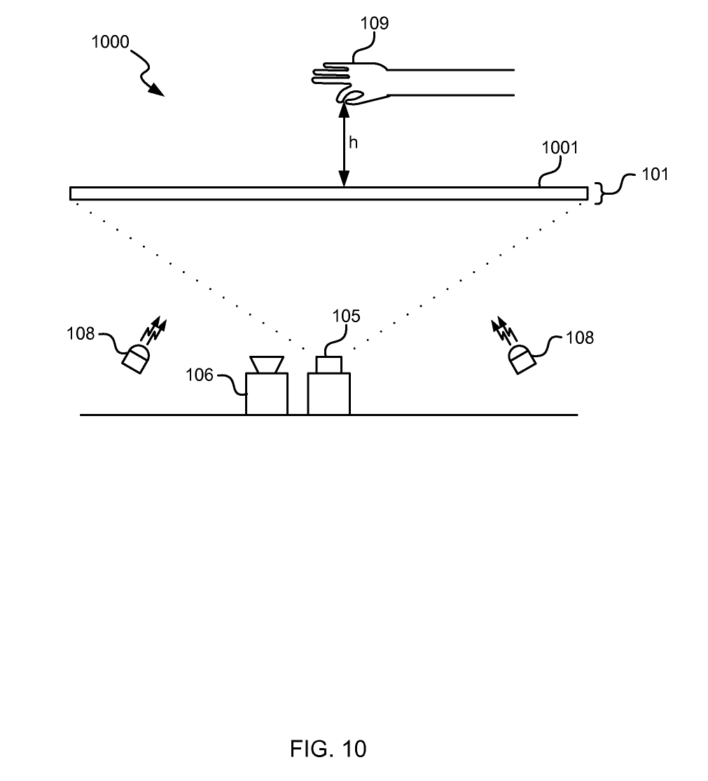

FIG. 1 shows an example schematic diagram of a surface computing device 100 in which user interaction with a 3D virtual environment is provided. Note that the surface computing device shown in FIG. 1 is just one example, and alternative surface computing device arrangements can also be used. Further alternative examples are illustrated with reference to FIG. 10 to 12, as described hereinbelow.

The term ‘surface computing device’ is used herein to refer to a computing device which comprises a surface which is used both to display a graphical user interface and to detect input to the computing device. The surface can be planar or can be non-planar (e.g. curved or spherical) and can be rigid or flexible. The input to the surface computing device can, for example, be through a user touching the surface or through use of an object (e.g. object detection or stylus input). Any touch detection or object detection technique used can enable detection of single contact points or can enable multi-touch input. Also note that, whilst in the following description the example of a horizontal surface is used, the surface can be in any orientation. Therefore, a reference to a ‘height above’ a horizontal surface (or similar) refers to a substantially perpendicular separation distance from the surface.

The surface computing device 100 comprises a surface layer 101. The surface layer 101 can, for example, be embedded horizontally in a table. In the example of FIG. 1, the surface layer 101 comprises a switchable diffuser 102 and a transparent pane 103. The switchable diffuser 102 is switchable between a substantially diffuse state and a substantially transparent state. The transparent pane 103 can be formed of, for example, acrylic, and is edge-lit (e.g. from one or more light emitting diodes (LED) 104), such that the light input at the edge undergoes total internal reflection (TIR) within the transparent pane 602. Preferably, the transparent pane 103 is edge-lit with infrared (IR) LEDs.

The surface computing device 100 further comprises a display device 105, an image capture device 106, and a touch detection device 107. The surface computing device 100 also comprises one or more light sources 108 (or illuminants) arranged to illuminate objects above the surface layer 101.

In this example, the display device 105 comprises a projector. The projector can be any suitable type of projector, such as an LCD, liquid crystal on silicon (LCOS), Digital Light Processing (DLP) or laser projector. In addition, the projector can be fixed or steerable. Note that, in some examples, the projector can also act as the light source for illuminating objects above the surface layer 101 (in which case the light sources 108 can be omitted).

The image capture device 106 comprises a camera or other optical sensor (or array of sensors). The type of light source 108 corresponds to the type of image capture device 106. For example, if the image capture device 106 is an IR camera (or a camera with an IR-pass filter), then the light sources 108 are IR light sources. Alternatively, if the image capture device 106 is a visible light camera, then the light sources 108 are visible light sources.

Similarly, in this example, the touch detection device 107 comprises a camera or other optical sensor (or array of sensors). The type of touch detection device 107 corresponds with the edge-illumination of the transparent pane 103. For example, if the transparent pane 103 is edge-lit with one or more IR LEDs, then the touch detection device 107 comprises an IR camera, or a camera with an IR-pass filter.

In the example shown in FIG. 1, the display device 105, image capture device 106, and touch detection device 107 are located below the surface layer 101. Other configurations are possible and a number of other configurations are described below with reference to FIG. 10 to 12. The surface computing device can, in other examples, also comprise a mirror or prism to direct the light projected by the projector, such that the device can be made more compact by folding the optical train, but this is not shown in FIG. 1.

In use, the surface computing device 100 operates in one of two modes: a ‘projection mode’ when the switchable diffuser 102 is in its diffuse state and an ‘image capture mode’ when the switchable diffuser 102 is in its transparent state. If the switchable diffuser 102 is switched between states at a rate which exceeds the threshold for flicker perception, anyone viewing the surface computing device sees a stable digital image projected on the surface.

The terms ‘diffuse state’ and ‘transparent state’ refer to the surface being substantially diffusing and substantially transparent, with the diffusivity of the surface being substantially higher in the diffuse state than in the transparent state. Note that in the transparent state the surface is not necessarily totally transparent and in the diffuse state the surface is not necessarily totally diffuse. Furthermore, in some examples, only an area of the surface can be switched (or can be switchable).

With the switchable diffuser 102 in its diffuse state, the display device 105 projects a digital image onto the surface layer 101. This digital image can comprise a graphical user interface (GUI) for the surface computing device 100 or any other digital image.

When the switchable diffuser 102 is switched into its transparent state, an image can be captured through the surface layer 101 by the image capture device 106. For example, an image of a user's hand 109 can be captured, even when the hand 109 is at a height ‘h’ above the surface layer 101. The light sources 108 illuminate objects (such as the hand 109) above the surface layer 101 when the switchable diffuser 102 is in its transparent state, so that the image can be captured. The captured image can be utilized to enhance user interaction with the surface computing device, as outlined in more detail hereinafter. The switching process can be repeated at a rate greater than the human flicker perception threshold.

In either the transparent or diffuse states, when a finger is pressed against the top surface of the transparent pane 103, it causes the TIR light to be scattered. The scattered light passes through the rear surface of the transparent pane 103 and can be detected by the touch detection device 107 located behind the transparent pane 103. This process is known as frustrated total internal reflection (FTIR). The detection of the scattered light by the touch detection device 107 enables touch events on the surface layer 101 to be detected and processed using computer-vision techniques, so that a user of the device can interact with the surface computing device. Note that in alterative examples, the image capture device 106 can be used to detect touch events, and the touch detection device 107 omitted.

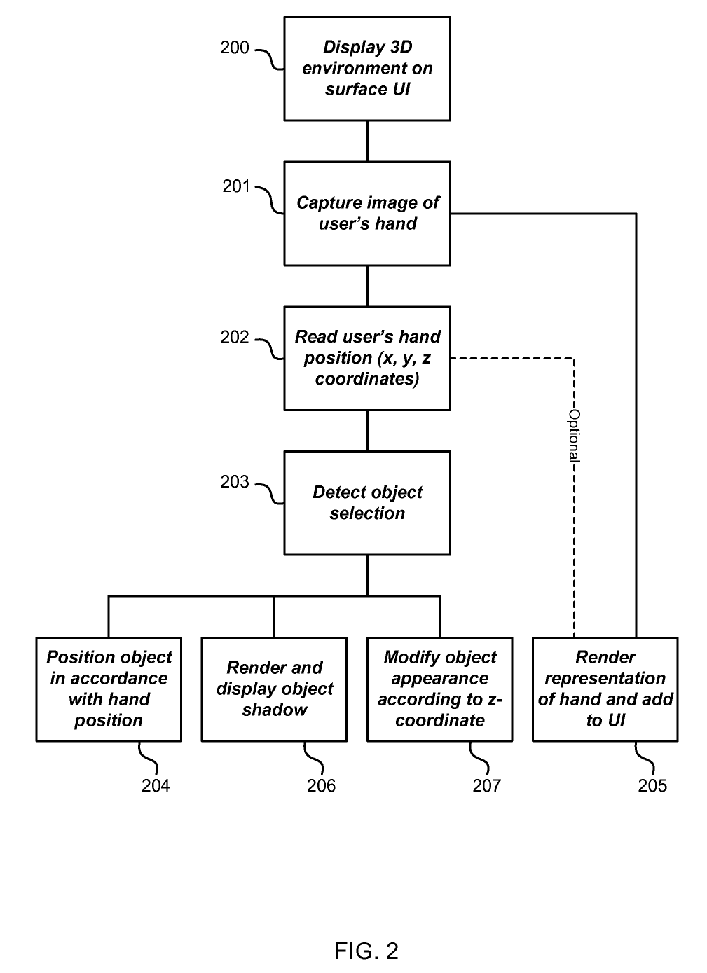

The surface computing device 100 described with reference to FIG. 1 can be used to enable a user to interact with a 3D virtual environment displayed in a user interface in a direct and intuitive manner, as outlined with reference to FIG. 2. The technique described below allows users to lift virtual objects off a (virtual) ground and control their position in three dimensions. The technique maps the separation distance from the hand 109 to the surface layer 101 to the height of the virtual object above the virtual floor. Hence, a user can intuitively pick up an object and move it in the 3D environment and drop it off in a different location.

Referring to FIG. 2, firstly the 3D environment is rendered by the surface computing device, and displayed 200 by the display device 105 on the surface layer 101 when the switchable diffuser 102 is in the diffuse state. The 3D environment can, for example, show a virtual scene comprising one or more objects. Note that any type of application can be used in which three-dimensional manipulation is utilized, such as (for example) games, modeling applications, document storage applications, and medical applications. Whilst multiple fingers and even whole-hands can be used to interact with these objects through touch detection with the surface layer 101, tasks that involve lifting, stacking or other high degree of freedom interactions are still difficult to perform.

During the time instances when the switchable diffuser 102 is in the transparent state, the image capture device 106 is used to capture 201 images through the surface layer 101. These images can show one or more hands of one or more users above the surface layer 101. Note that fingers, hands or other objects that are in contact with the surface layer can be detected by the FTIR process and the touch detection device 107, which enables discrimination between objects touching the surface, and those above the surface.

The captured images can be analyzed using computer vision techniques to determine the position 202 of the user's hand (or hands). A copy of the raw captured image can be converted to a black and white image using a pixel value threshold to determine which pixels are black and which are white. A connected component analysis can then be performed on the black and white image. The result of the connected component analysis is that connected areas that contain reflective objects (i.e. connected white blocks) are labeled as foreground objects. In this example, the foreground object is the hand of a user.

The planar location of the hand relative to the surface layer 101 (i.e. the x and y coordinates of the hand in the plane parallel to the surface layer 101 ) can be determined simply from the location of the hands in the image. In order to estimate the height of the hand above the surface layer (i.e. the hand's z-coordinate or the separation distance between the hand and the surface layer), several different techniques can be used.

In a first example, a combination of the black and white image and the raw captured image can be used to estimate the hand's height above the surface layer 101. The location of the ‘center of mass’ of the hand is found by determining the central point of the white connected component in the black and white image. The location of the center of mass is then recorded, and the equivalent location in the raw captured image is analyzed. The average pixel intensity (e.g. the average grey-level value if the original raw image is a grayscale image) is determined for a predetermined region around the center of mass location. The average pixel intensity can then be used to estimate the height of the hand above the surface. The pixel intensity that would be expected for a certain distance from the light sources 108 can be estimated, and this information can be used to calculate the height of the hand.

In a second example, the image capture device 106 can be a 3D camera capable of determining depth information for the captured image. This can be achieved by using a 3D time-of-flight camera to determine depth information along with the captured image. This can use any suitable technology for determining depth information, such as optical, ultrasonic, radio or acoustic signals. Alternatively, a stereo camera or pair of cameras can be used for the image capture device 106, which capture the image from different angles, and allow depth information to be calculated. Therefore, the image captured during the switchable diffuser's transparent state using such an image capture device enables the height of the hand above the surface layer to be determined.

In a third example, a structured light pattern can be projected onto the user's hand when the image is captured. If a known light pattern is used, then the distortion of the light pattern in the captured image can be used to calculate the height of the user's hand. The light pattern can, for example, be in the form of a grid or checkerboard pattern. The structured light pattern can be provided by the light source 108, or alternatively by the display device 105 in the case that a projector is used.

In a fourth example, the size of the user's hand can be used to determine the separation between the user's hand and the surface layer. This can be achieved by the surface computing device detecting a touch event by the user (using the touch detection device 107), which therefore indicates that the user's hand is (at least partly) in contact with the surface layer. Responsive to this, an image of the user's hand is captured. From this image, the size of the hand can be determined. The size of the user's hand can then be compared to subsequent captured images to determine the separation between the hand and the surface layer, as the hand appears smaller the further from the surface layer it is.

In addition to determining the height and location of the user's hand, the surface computing device is also arranged to use the images captured by the image capture device 106 to detect 203 selection of an object by the user for 3D manipulation. The surface computing device is arranged to detect a particular gesture by the user that indicates that an object is to be manipulated in 3D (e.g. in the z-direction). An example of such a gesture is the detection of a ‘pinch’ gesture.

Whenever the thumb and index finger of one hand approach each other and ultimately make contact, a small, ellipsoid area is cut out from the background. This therefore leads to the creation of a small, new connected component in the image, which can be detected using connected component analysis. This morphological change in the image can be interpreted as the trigger for a ‘pick-up’ event in the 3D environment. For example, the appearance of a new, small connected component within the area of a previously detected, bigger component triggers a pick-up of an object in the 3D environment that is located at the location of the user's hand (i.e. at the point of the pinch gesture). Similarly, the disappearance of the new connected component triggers a drop-off event.

In alternative examples, different gestures can be detected and used to trigger 3D manipulation events. For example, a grab or scoop gesture of the user's hand can be detected.

Note that the surface computing device is arranged to periodically detect gestures and to determine the height and location of the user's hand, and these operations are not necessarily performed in sequence, but can be performed concurrently or in any order.

When a gesture is detected and triggers a 3D manipulation event for a particular object in the 3D environment, the position of the object is updated 204 in accordance with the position of the hand above the surface layer. The height of the object in the 3D environment can be controlled directly, such that the separation between the user's hand and the surface layer 101 is directly mapped to the height of the virtual object from a virtual ground plane. As the user's hand is moved above the surface layer, so the picked-up object correspondingly moves. Objects can be dropped off at a different location when users let go of the detected gesture.

This technique enables the intuitive operation of interactions with 3D objects on surface computing devices that were difficult or impossible to perform when only touch-based interactions could be detected. For example, users can stack objects on top of each other in order to organize and store digital information. Objects can also be put into other virtual objects for storage. For example, a virtual three-dimensional card box can hold digital documents which can be moved in and out of this container by this technique.

Other, more complex interactions can be performed, such as assembly of complex 3D models from constituting parts, e.g. with applications in the architectural domain. The behavior of the virtual objects can also be augmented with a gaming physics simulation, for example to enable interactions such as folding soft, paper like objects or leafing through the pages of a book more akin to the way users perform this in the real world. This technique can be used to control objects in a game such as a 3D maze where the player moves a game piece from the starting position at the bottom of the level to the target position at the top of the level. Furthermore, medical applications can be enriched by this technique as volumetric data can be positioned, oriented and/or modified in a manner similar to interactions with the real body.

Furthermore, in traditional GUIs, fine control of object layering often involves dedicated, often abstract UI elements such as a layer palette (e.g. Adobe™ Photoshop™) or context menu elements (e.g. Microsoft™ Powerpoint™). The above-described technique allows for a more literal layering control. Objects representing documents or photographs can be stacked on top of each other in piles and selectively removed as desired.

However, when interacting with virtual objects using the above-described technique a cognitive disconnect on the part of the user can occur because the image of the object shown on the surface layer 101 is two-dimensional. Once the user lifts his hand off the surface layer 101 the object under control is not in direct contact with the hand anymore which can cause the user to be disoriented and gives rise to an additional cognitive load, especially when fine-grained control over the object's position and height is preferred for the task at hand. To counteract this one or more of the rendering techniques described below can be used to compensate for the cognitive disconnect and provide the user with the perception of a direct interaction with the 3D environment on the surface computing device.

Firstly, to address the cognitive disconnect, a rendering technique is used to increase the perceived connection between the user's hand and virtual object. This is achieved by using the captured image of the user's hand (captured by the image capture device 106 as discussed above) to render 205 a representation of the user's hand in the 3D environment. The representation of the user's hand in the 3D environment is geometrically aligned with the user's real hands, so that the user immediately associates his own hands with the representations. By rendering a representation of the hand in the 3D environment, the user does not perceive a disconnection, despite the hand being above, and not in contact with, the surface layer 101. The presence of a representation of the hand also enables the user to more accurately position his hands when they are being moved above the surface layer 101.

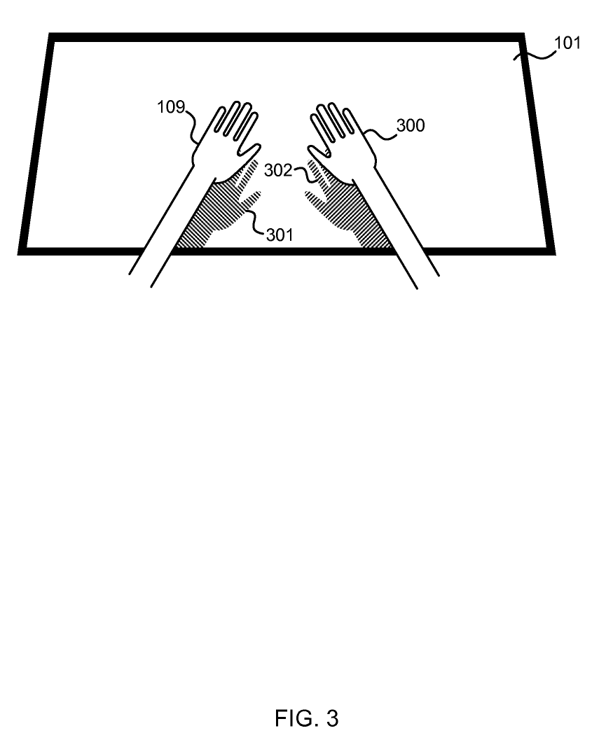

In one example, the representation of the user's hand that is used is in the form of a representation of a shadow of the hand. This is a natural and instantly understood representation, and the user immediately connects this with the impression that the surface computing device is brightly lit from above. This is shown illustrated in FIG. 3, where a user has placed two hands 109 and 300 over the surface layer 101, and the surface computing device has rendered representation 301 and 302 of shadows (i.e. virtual shadows) on the surface layer 101 in locations that correspond to the location of the user's hands.

The shadow representations can be rendered by using the captured image of the user's hand discussed above. As stated above, the black and white image that is generated contains the image of the user's hand in white (as the foreground connected component). The image can be inverted, such that the hand is now shown in black, and the background in white. The background can then be made transparent to leave the black ‘silhouette’ of the user's hand.

The image comprising the user's hand can be inserted into the 3D scene in every frame (and updated as new images are captured). Preferably, the image is inserted into the 3D scene before lighting calculations are performed in the 3D environment, such that within the lighting calculation the image of the user's hand casts a virtual shadow into the 3D scene that is correctly aligned with the objects present. Because the representations are generated from the image captured of the user's hand, they accurately reflect the geometric position of the user's hand above the surface layer, i.e. they are aligned with the planar position of the user's hand at the time instance that the image was captured. The generation of the shadow representation is preferably performed on a graphics processing unit (GPU). The shadow rendering is performed in real-time, in order to provide the perception that it is the user's real hands that are casting the virtual shadow, and so that that the shadow representations move in unison with the user's hands.

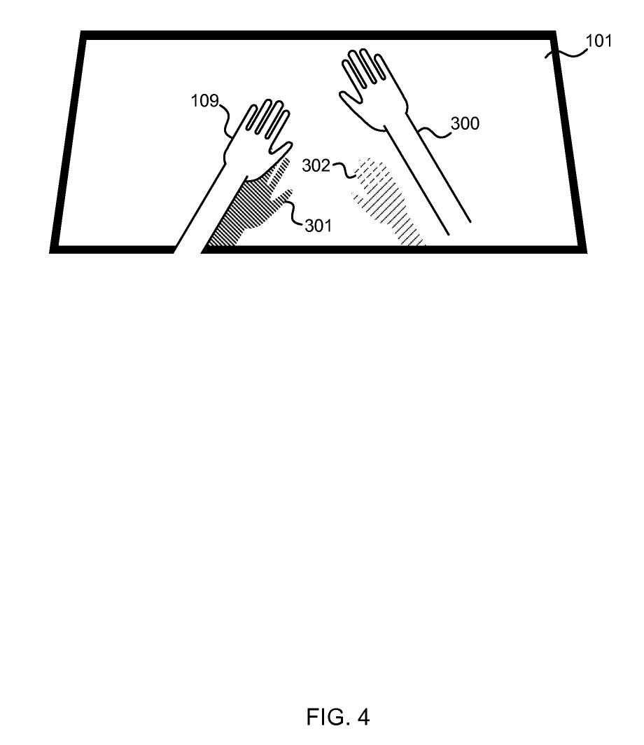

The rendering of the representation of the shadow can also optionally utilize the determination of the separation between the user's hand and the surface layer. For example, the rendering of the shadows can cause the shadows to become more transparent or dim as the height of the user's hands above the surface layer increases. This is shown illustrated in FIG. 4, where the hands 109 and 300 are in the same planar location relative to the surface layer 101 as they were in FIG. 3, but in FIG. 4 hand 300 is higher above the surface layer than hand 109. The shadow representation 302 is smaller, due to the hand being further away from the surface layer, and hence smaller in the image captured by the image capture device 106. In addition, the shadow representation 302 is more transparent than shadow representation 301. The degree of transparency can be set to be proportional to the height of the hand above the surface layer. In alternative examples, the representation of the shadow can be made more dim or diffuse as the height of the hand is increased.

In an alternative example, instead of rendering representations of a shadow of the user's hand, representations of a reflection of the user's hand can be rendered. In this example, the user has the perception that he is able to see a reflection of his hands on the surface layer. This is therefore another instantly understood representation. The process for rendering a reflection representation is similar to that of the shadow representation. However, in order to be able to provide a color reflection, the light sources 108 produce visible light, and the image capture device 106 captures a color image of the user's hand above the surface layer. A similar connected component analysis is performed to locate the user's hand in the captured image, and the located hand can then be extracted from the color captured image and rendered on the display beneath the user's hand.

In a further alternative example, the rendered representation can be in the form of a 3D model of a hand in the 3D environment. The captured image of the user's hand can be analyzed using computer vision techniques, such that the orientation (e.g. in terms of pitch, yaw and roll) of the hand is determined, and the position of the digits analyzed. A 3D model of a hand can then be generated to match this orientation and provided with matching digit positions. The 3D model of the hand can be modeled using geometric primitives that are animated based on the movement of the user's limbs and joints. In this way, a virtual representation of the users hand can be introduced into the 3D scene and is able to directly interact with the other virtual objects in the 3D environments. Because such a 3D hand model exists within the 3D environment (as opposed to being rendered on it), the users can interact more directly with the objects, for example by controlling the 3D hand model to exert forces onto the sides of an object and hence pick it up through simple grasping.

In a yet further example, as an alternative to generating a 3D articulated hand model, a particle system-based approach can be used. In this example, instead of tracking the user's hand to generate the representation, only the available height estimation is used to generate the representation. For example, for each pixel in the camera image a particle can be introduced into the 3D scene. The height of the individual particles introduced into the 3D scene can be related to the pixel brightness in the image (as described hereinabove)—e.g. very bright pixels are close to the surface layer and darker pixels are further away. The particles combine in the 3D environment to give a 3D representation of the surface of the user's hand. Such an approach enables users to scoop objects up. For example, one hand can be positioned onto the surface layer (palm up) and the other hand can then be used to push objects onto the palm. Objects already residing on the palm can be dropped off by simply tilting the palm so that virtual objects slide off.

The generation and rendering of representations of the user's hand or hands in the 3D environment therefore enables the user to have an increased connection to objects that are manipulated when the user's hands are not in contact with the surface computing device. In addition, the rendering of such representations also improves user interaction accuracy and usability in applications where the user does not manipulate objects from above the surface layer. The visibility of a representation that the user immediately recognizes aids the user in visualizing how to interact with a surface computing device.

Referring again to FIG. 2, a second rendering technique is used to enable the user to visualize and estimate the height of an object being manipulated. Because the object is being manipulated in a 3D environment, but is being displayed on a 2D surface, it is difficult for the user to understand whether an object is positioned above the virtual floor of the 3D environment, and if so, how high it is. In order to counteract this, a shadow for the object is rendered 206 and displayed in the 3D environment.

The processing of the 3D environment is arranged such that a virtual light source is situated above the surface layer. A shadow is then calculated and rendered for the object using the virtual light source, such that the distance between object and shadow is proportional to the height of the object. Objects on the virtual floor are in contact with their shadow, and the further away an object is from the virtual floor the greater the distance to its own shadow.

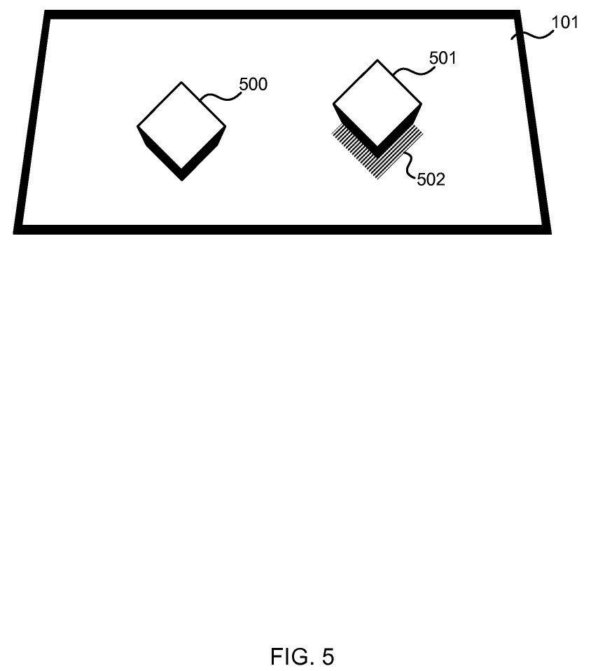

The rendering of object shadows is illustrated in FIG. 5. A first object 500 is displayed on the surface layer 101, and this object is in contact with the virtual floor of the 3D environment. A second object 501 is displayed on the surface layer 101, and has the same y-coordinate as the first object 500 in the plane of the surface layer (in the orientation shown in FIG. 5). However, the second object 501 is raised above the virtual floor of the 3D environment. A shadow 502 is rendered for the second object 501, and the spacing between the second object 501 and the shadow 502 is proportional to the height of the object. Without the presence of an object shadow, it is difficult for the user to distinguish whether the object is raised above the virtual floor, or whether it is in contact with the virtual floor, but has a different y-coordinate to the first object 500.

Preferably, the object shadow calculation is performed entirely on the GPU so that realistic shadows, including self-shadowing and shadows cast onto other virtual objects, are computed in real-time. The rendering of object shadows conveys an improved depth perception to the users, and allows users to understand when objects are on-top of or above other objects. The object shadow rendering can be combined with hand shadow rendering, as described above.

The techniques described above with reference to FIG. 3 to 5 can be further enhanced by giving the user increased control of the way that the shadows are rendered in the 3D environment. For example, the user can control the position of the virtual light source in the 3D environment. Typically, the virtual light source can be positioned directly above the objects, such that the shadows cast by the user's hand and the objects are directly below the hand and objects when raised. However, the user can control the position of the virtual light source such that it is positioned at a different angle. The result of this is that the shadows cast by the hands and/or objects stretch out to a greater degree away from the position of the virtual light source. By positioning the virtual light source such that the shadows are more clearly visible for a given scene in the 3D environment the user is able to gain a finer degree of height perception, and hence control over the objects. The virtual light source's parameters can also be manipulated, such as an opening-angle of the light cone and light decay. For example a light source very far away would emit almost parallel light beams, while a light source close by (such as a spotlight) would emit diverging light beams which would result in different shadow renderings.

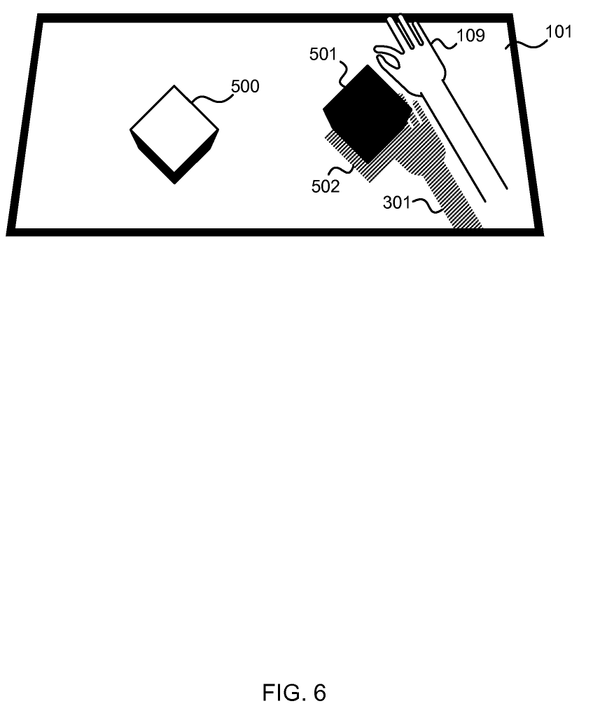

Referring once more to FIG. 2, to further improve the depth perception of objects being manipulated in the 3D environment, a third rendering technique is used to modify 207 the appearance of the object in dependence on the object's height above the virtual floor (as determined by the estimation of the height of the user's hand above the surface layer). Three different example rendering techniques are described below with reference to FIG. 6 to 9 that change an object's render style based on the height of that object. As with the previous rendering techniques, all the computations for these techniques are performed within the lighting computation performed on the GPU. This enables the visual effects to be calculated on a per-pixel basis, thereby allowing for smoother transitions between different render styles and improved visual effects.

With reference to FIG. 6, the first technique to modify the object's appearance while being manipulated is known as a “fade-to-black” technique. With this technique the color of an object is modified in dependence on its height above the virtual floor. For example, in every frame of the rendering operation the height value (in the 3D environment) of each pixel on the surface of the object in the 3D scene is compared against a predefined height threshold. Once the pixel's position in 3D coordinates exceeds this height threshold, the color of the pixel is darkened. The darkening of the pixel's color can be progressive with increasing height, such that the pixel is increasingly darkened with increasing height until the color value is entirely black.

Therefore, the result of this technique is that objects that move away from the virtual ground are gradually de-saturated, starting from the top most point. When the object reaches the highest possible position it is rendered solid black. Conversely, when lowered back down the effect is inverted, such that the object regains its original color or texture.

This is illustrated in FIG. 6, where the first object 500 (as described with reference to FIG. 5) is in contact with the virtual ground. The second object 501 has been selected by the user (using the ‘pinch’ gesture), and the user has raised his hand 109 above the surface layer 101, and the estimation of the height of the user's hand 109 above the surface layer 101 is used to control the height of the second object 501 in the 3D environment. The position of the user's hand 109 is indicated using the hand shadow representation 301 (described above), and the height of the object in the 3D environment is indicated by the object shadow 502 (also described above). The user's hand 109 is sufficiently separated from the surface layer 101 that the second object 501 is completely above the predetermined height threshold, and the object is high enough that the pixels of the second object 501 are rendered black.

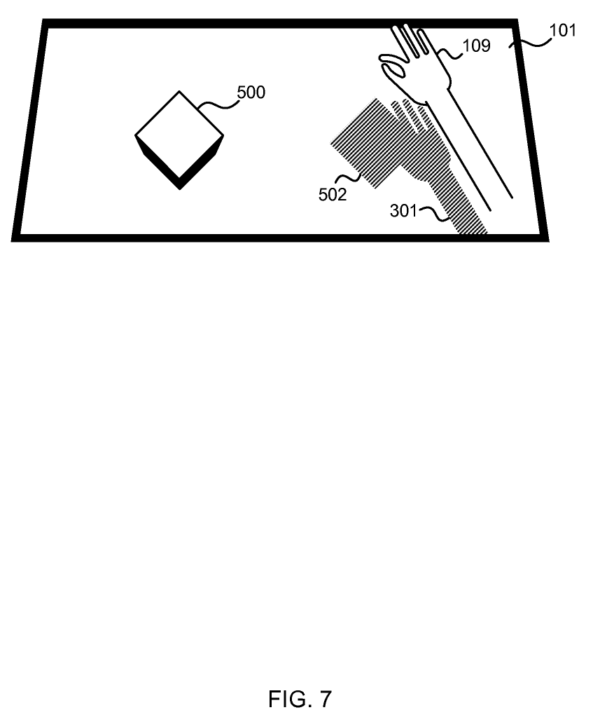

With reference to FIG. 7, the second technique to modify the object's appearance while being manipulated is known as a “fade-to-transparent” technique. With this technique the opaqueness (or opacity) of an object is modified in dependence on its height above the virtual floor. For example, in every frame of the rendering operation the height value (in the 3D environment) of each pixel on the surface of the object in the 3D scene is compared against a predefined height threshold. Once the pixel's position in 3D coordinates exceeds this height threshold, a transparency value (also known as an alpha value) of the pixel is modified, such that the pixel becomes transparent.

Therefore, the result of this technique is that, with increasing height, objects change from being opaque to being completely transparent. The raised object is cut-off at the predetermined height threshold. Once the entire object is higher than the threshold only the shadow of the object is rendered.

This is illustrated in FIG. 7. Again, for comparison, the first object 500 is in contact with the virtual ground. The second object 501 has been selected by the user (using the ‘pinch’ gesture), and the user has raised his hand 109 above the surface layer 101, and the estimation of the height of the user's hand 109 above the surface layer 101 is used to control the height of the second object 501 in the 3D environment. The position of the user's hand 109 is indicated using the hand shadow representation 301 (described above), and the height of the object in the 3D environment is indicated by the object shadow 502 (also described above). The user's hand 109 is sufficiently separated from the surface layer 101 that the second object 501 is completely above the predetermined height threshold, and thus the object is completely transparent such that only the object shadow 502 remains.

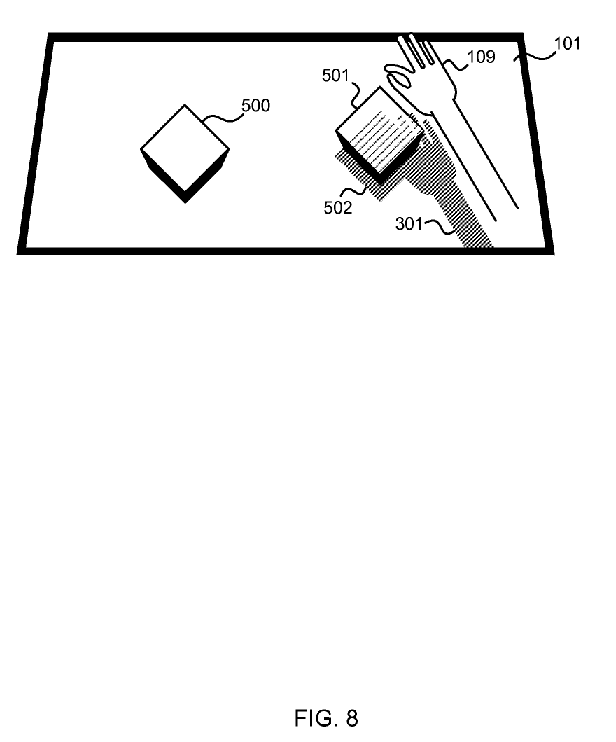

With reference to FIG. 8, the third technique to modify the object's appearance while being manipulated is known as a “dissolve” technique. This technique is similar to the “fade-to-transparent” technique in that the opaqueness (or opacity) of the object is modified in dependence on its height above the virtual floor. However, with this technique the pixel transparency value is varied gradually as the object's height is varied, such that the transparency value of each pixel in the object is proportional to that pixel's height.

Therefore, the result of this technique is that, with increasing height, the object gradually disappears as it is raised (and gradually re-appears as it is lowered). Once the object is raised sufficiently high above the virtual ground, then it completely disappears and only the shadow remains (as illustrated in FIG. 7).

The “dissolve” technique is illustrated in FIG. 8. In this example, the user's hand 109 is separated from the surface layer 101 such that the second object 501 is partially transparent (e.g. the shadows have begun to become visible through the object).

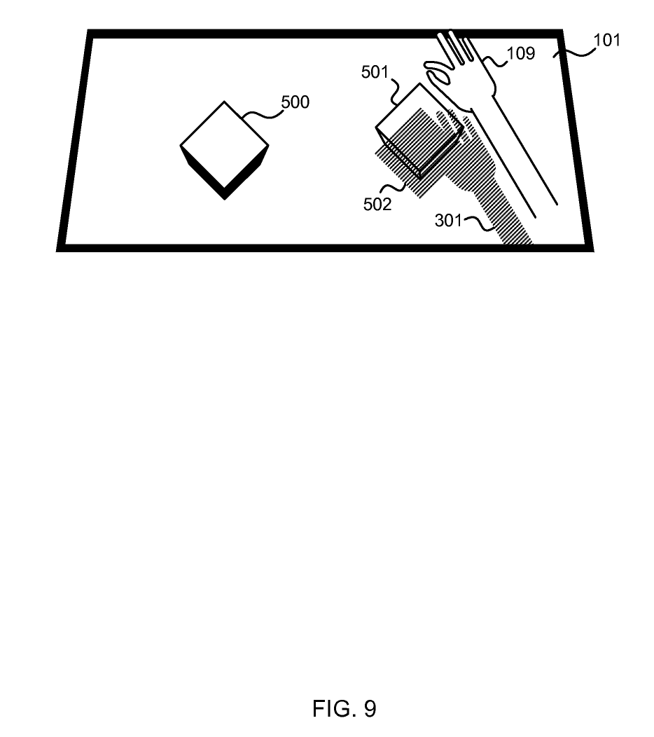

A variation of the “fade-to-transparent” and “dissolve” techniques is to retain a representation of the object as it becomes less opaque, so that the object does not completely disappear from the surface layer. An example of this is to convert the object to a wireframe version of its shape as it is raised and disappears from the display on the surface layer. This is illustrated in FIG. 9, where the user's hand 109 is sufficiently separated from the surface layer 101 that the second object 501 is completely transparent, but a 3D wireframe representation of the edges of the object is shown on the surface layer 101.

The techniques described above with reference to FIG. 6 to 9 therefore assist the user in perceiving the height of an object in a 3D environment. In particular, when the user is interacting with such an object by using their hand (or hands) separated from the surface computing device, such rendering techniques mitigate the disconnection from the objects.

A further enhancement that can be used to increase the user's connection to the object's being manipulated in the 3D environment is to increase the impression to the user that they are holding the object in their hand. In other words, the user perceives that the object has left the surface layer 101 (e.g. due to dissolving or fading-to-transparent) and is now in the user's raised hand. This can be achieved by controlling the display means 105 to project an image onto the user's hand when the switchable diffuser 102 is in the transparent state. For example, if the user has selected and lifted a red block by raising his hand above the surface layer 101, then the display means 105 can project red light onto the user's raised hand. The user can therefore see the red light on his hand, which assists the user in associating his hand with holding the object.

As stated hereinabove, the 3D environment interaction and control techniques described with reference to FIG. 2 can be performed using any suitable surface computing device. The above-described examples were described in the context of the surface computing device of FIG. 1. However, other surface computing device configurations can also be used, as described below with reference to further examples in FIGS. 10, 11 and 12.

Reference is first made to FIG. 10. This shows a surface computing device 1000 which does not use a switchable diffuser. Instead, the surface computing device 1000 comprises a surface layer 101 having a transparent rear projection screen, such as a holoscreen 1001. The transparent rear projection screen 1001 enables the image capture device 106 to image through the screen at instances when the display device 105 is not projecting an image. The display device 105 and image capture device 106 therefore do not need to be synchronized with a switchable diffuser. Otherwise, the operation of the surface computing device 1001 is the same as that outlined above with reference to FIG. 1. Note that the surface computing device 1000 can also utilize a touch detection device 107 and/or a transparent pane 103 FTIR touch detection if preferred (not shown in FIG. 10). The image capture device 106 can be a single camera, a stereo camera or a 3D camera, as described above with reference to FIG. 1.

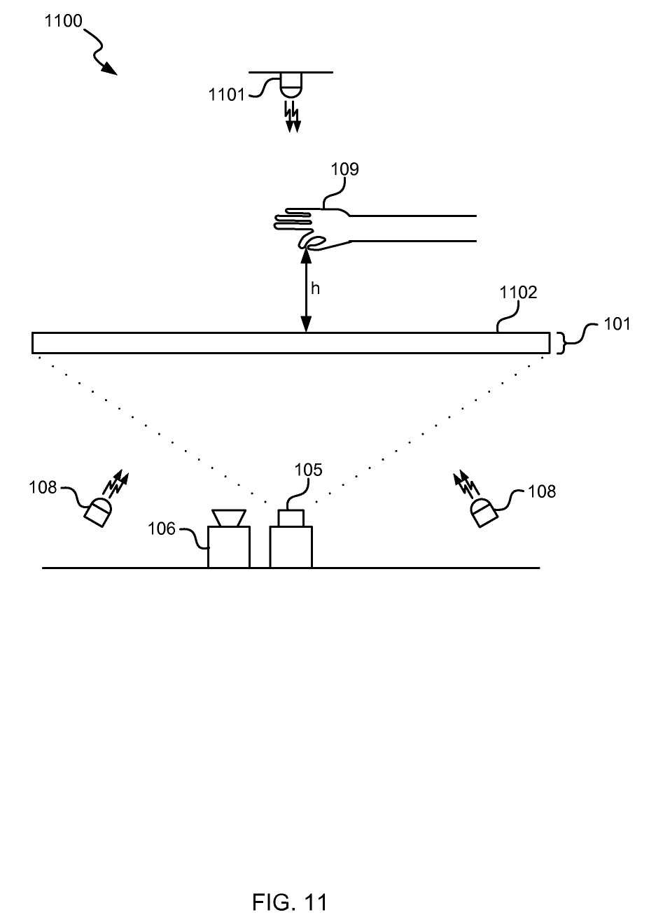

Reference is now made to FIG. 11, which illustrates a surface computing device 1100 that comprises a light source 1101 above the surface layer 101. The surface layer 101 comprises a rear projection screen 1102, which is not switchable. The illumination above the surface layer 101 provided by the light source 1101 causes real shadows to be cast onto the surface layer 101 when the user's hand 109 is placed above the surface layer 101. Preferably, the light source 1101 provides IR illumination, so that the shadows cast on the surface layer 101 are not visible to the user. The image capture device 106 can capture images of the rear projection screen 1102, which comprise the shadows cast by the user's hand 109. Therefore, realistic images of hand shadows can be captured for rendering in the 3D environment. In addition, light sources 108 illuminate the rear projection screen 1102 from below, such that when a user touches the surface layer 101, the light is reflected back into the surface computing device 1100, where it can be detected by the image capture device 106. Therefore, the image capture device 106 can detect touch events as bright spots on the surface layer 101 and shadows as darker patches.

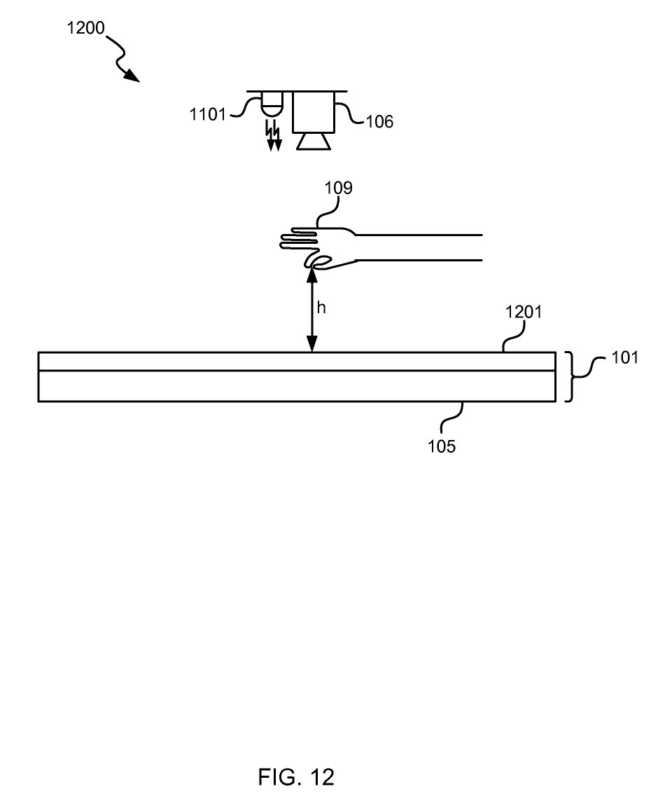

Reference is next made to FIG. 12, which illustrates a surface computing device 1200 which utilizes an image capture device 106 and light source 1101 located above the surface layer 101. The surface layer 101 comprises a direct touch input display comprising a display device 105 such as an LCD screen and a touch sensitive layer 1201 such as a resistive or capacitive touch input layer. The image capture device 106 can be a single camera, stereo camera or 3D camera. The image capture device 106 captures images of the user's hand 109, and estimates the height above the surface layer 101 in a similar manner to that described above for FIG. 1. The display device 105 displays the 3D environment and hand shadows (as described above) without the use of a projector. Note that the image capture device 106 can, in alternative examples, be positioned in different locations. For example, one or more image capture devices can be located in a bezel surrounding the surface layer 101.

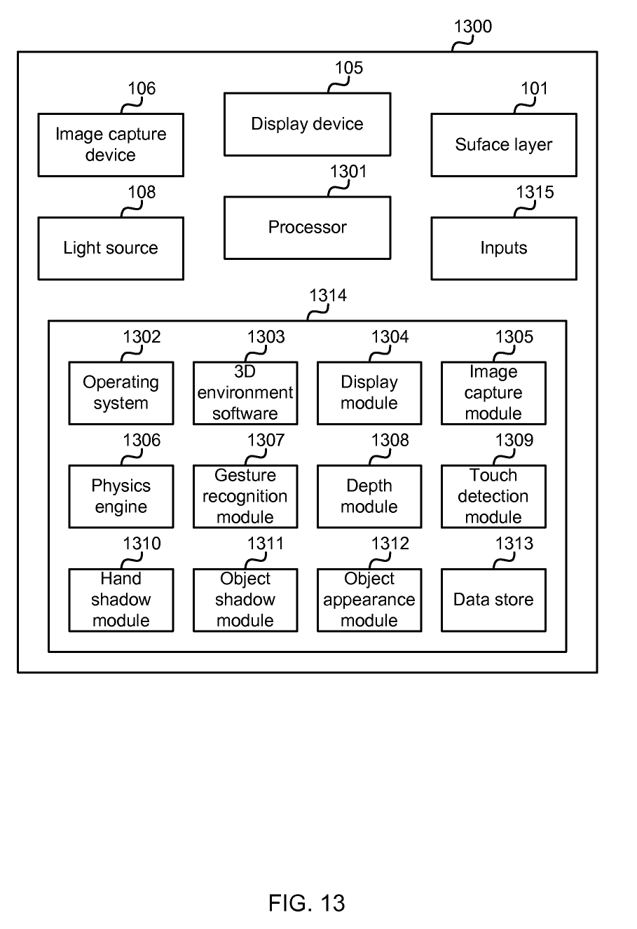

FIG. 13 illustrates various components of an exemplary computing-based device 1300 which can be implemented as any form of a computing and/or electronic device, and in which embodiments of the techniques described herein can be implemented.

Computing-based device 1300 comprises one or more processors 1301 which can be microprocessors, controllers, GPUs or any other suitable type of processors for processing computing executable instructions to control the operation of the device in order to perform the techniques described herein. Platform software comprising an operating system 1302 or any other suitable platform software can be provided at the computing-based device 1300 to enable application software 1303-1313 to be executed on the device.

The application software can comprise one or more of:
3D environment software 1303 arranged to generate the 3D environment comprising lighting effects and in which objects can be manipulated;
A display module 1304 arranged to control the display device 105;
An image capture module 1305 arranged to control the image capture device 106;
A physics engine 1306 arranged to control the behavior of the objects in the 3D environment;
A gesture recognition module 1307 arranged to receive data from the image capture module 1305 and analyze the data to detect gestures (such as the ‘pinch’ gesture described above);
A depth module 1308 arranged to estimate the separation distance between the user's hand and the surface layer (e.g. using data captured by the image capture device 106);
A touch detection module 1309 arranged to detect touch events on the surface layer 101;
A hand shadow module 1310 arranged to generate and render hand shadows in the 3D environment using data received from the image capture device 105;
An object shadow module 1311 arranged to generate and render object shadows in the 3D environment using data on the height of the object;
An object appearance module 1312 arranged to modify the appearance of the object in dependence on the height of the object in the 3D environment; and
A data store 1313 arranged to store captured images, height information, analyzed data, etc.

The computer executable instructions can be provided using any computer-readable media, such as memory 1314. The memory is of any suitable type such as random access memory (RAM), a disk storage device of any type such as a magnetic or optical storage device, a hard disk drive, or a CD, DVD or other disc drive. Flash memory, EPROM or EEPROM can also be used.

The computing-based device 1300 comprises at least one image capture device 106, at least one light source 108, at least one display device 105 and a surface layer 101. The computing-based device 1300 also comprises one or more inputs 1315 which are of any suitable type for receiving media content, Internet Protocol (IP) input or other data.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method of controlling a surface computing device, comprising:
capturing an image of a hand of a user interacting with a user interface displayed on a surface layer of the surface computing device;
using the image to render a corresponding representation of the hand; and
displaying the representation in the user interface on the surface layer, such that the representation is geometrically aligned with the hand.

2. A method according to claim 1, wherein the representation is a representation of a shadow of the hand on the surface layer.

3. A method according to claim 1, wherein the representation is a representation of a reflection of the hand on the surface layer.

4. A method according to claim 1, wherein the steps of capturing an image, using the image, and displaying the representation are performed in real-time, such that movement of the hand causes the representation to correspondingly move on the user interface.

5. A method according to claim 1, further comprising the step of determining a separation distance between the hand and the surface layer.

6. A method according to claim 5, wherein the representation is rendered such that the representation has a transparency related to the separation distance.

7. A method according to claim 5, wherein the step of determining a separation distance between the hand and the surface layer comprises analyzing an average pixel intensity of the image of the hand.

8. A method according to claim 5, further comprising the steps of:
displaying a representation of a 3D environment in the user interface;
detecting selection by a user of an object rendered in the 3D environment;
determining a planar location of the hand relative to the surface layer; and
controlling the display of the object such that the object's position in the 3D environment is related to the separation distance and planar location of the hand.

9. A method according to claim 8, wherein the step of controlling the display of the object further comprises modifying at least one parameter relating to the object's appearance in dependence on the separation distance.

10. A method according to claim 9, wherein the parameter relating to the object's appearance comprises at least one of: a color value for the object; and a transparency value for the object.

11. A method according to claim 9, wherein the step of modifying comprises modifying the at least one parameter if the separation distance is greater than a predetermined threshold.

12. A method according to claim 8, further comprising the steps of:
calculating a shadow cast by the object in accordance with the object's position in the 3D environment; and
rendering the shadow cast by the object in the 3D environment.

13. A surface computing device, comprising:
a processor;
a surface layer;
a display device arranged to display a user interface on the surface layer;
an image capture device arranged to capture an image of a hand of a user interacting with the surface layer; and
a memory arranged to store executable instructions to cause the processor to render a corresponding representation of the hand from the image and add the representation to the user interface, such that, when displayed by the display device the representation is geometrically aligned with the hand.

14. A surface computing device according to claim 13, wherein the display device comprises one of: a projector; and an LCD panel.

15. A surface computing device according to claim 13, wherein the image capture device comprises one of: a video camera; a stereo camera; and a 3D camera.

16. A surface computing device according to claim 13, wherein the surface layer comprises a switchable diffuser having a first mode of operation in which the switchable diffuser is substantially diffuse and a second mode of operation in which the switchable diffuser is substantially transparent.

17. A surface computing device according to claim 13, wherein the surface layer comprises one of: a rear projection screen; a holoscreen; and a touch sensitive layer.

18. A surface computing device according to claim 13, further comprising a light source arranged to illuminate the hand of the user.

19. A surface computing device according to claim 18, wherein the light source comprises at least one of: an infra-red light source; and a structured light pattern source.

20. A method of controlling a surface computing device, comprising:
displaying a representation of a 3D environment in a user interface on a surface layer of the surface computing device;
detecting selection by a user of an object rendered in the 3D environment;
capturing an image of a hand of the user;
determining a separation distance between the hand and the surface layer, and a planar location of the hand relative to the surface layer;
using the image to render a corresponding representation of the hand;
displaying the corresponding representation in the 3D environment, such that the corresponding representation is geometrically aligned with the planar location of the hand; and
controlling the display of the object such that the object's position in the 3D environment is related to the separation distance and planar location of the hand.
